(19) United States
(12) Patent Application Publication
(10) Pub. No.: US 2011/0214135 A1
(43) Pub. Date: Sep. 1, 2011

(54) DATA PROCESSING DEVICE

(75) Inventors: Takashi Furusho, Saitama (JP); Takashi Kobayashi, Kanagawa (JP); Kenji Hino, Saitama (JP); Tetsuya Uchiyama, Saitama (JP); Yoshitaka Ono, Saitama (JP)

(73) Assignee: PIONEER CORPORATION, Kawasaki-shi, Kanagawa (JP)

(21) Appl. No.: 13/126,813

(22) PCT Filed: Oct. 31, 2008
(86) PCT No.: PCT/JP2008/069904

§ 371 Date: Apr. 29, 2011

(51) Int. Cl. G11B 17/051

(52) U.S. Cl. 720/624; G9B/17.032

(57) ABSTRACT

There is provided a data processing device able to surely eject a recording medium out of a main body of the device even when the recording medium is received in a case while a locking member having adherence and elasticity of the case is locked with a center hole of the recording medium.

A CD player includes: a main body of the device 3; a carrying unit 5 for ejecting and retracting a CD 2 from the main body of the device 3; a clamping and reading out unit 6 for reading out data recorded on the CD 2; and a microcomputer 4. The carrying unit 5 includes: a disc guide 17; and a roller arm 18 having a carrying roller 20. The microcomputer 4 makes the turntable 26 of the clamping and reading out unit 6 rotate while the CD 2 is held between the disc guide 17 and the carrying roller 20 when the carrying unit 5 fails to eject the CD 2 out of the main body of the device 3.

### TECHNICAL FIELD

This invention relates to a data processing device configured to read out data from a recording medium such as Compact Disc.

### BACK GROUND ART

A data processing device (for example, see Patent Document 1) to read out data from a recording medium such as CD (Compact Disc), DVD (Digital Versatile Disc), and BD (Blu-ray Disc) includes: a main body of the device; a carrying means for carrying in and out the recording medium to the main body of the device; a clamping and reading out means disposed in the main body of the device for clamping the recording medium and reading out data from the recording medium; and a cooperating member.

The carrying means includes: a disc guide; and a carrying roller disposed each other so as to move close to and away from each other and biased in a direction close to each other or in a direction away from each other. In the carrying means, the recording member is held between the disc guide and the carrying roller, and carried in and out to the main body of the device by rotating the carrying roller with a motor.

The clamping and reading out means includes: a carriage chassis made of elastic material such as rubber or damper and disposed movably relative to the main body of the device; and a clamping arm rotatably about one end of the carriage chassis.

The carriage chassis is provided with a turntable for rotating the recording medium, and an optical pickup for reading out data recorded on the recording medium.

The clamping arm is provided with a clamper for holding the recording medium between the turntable and the clamper at the other end of the clamping arm. The clamping arm is provided rotatably about the one end in the carriage chassis so that the other end is attachable and detachable to the carriage chassis.

The clamping and reading out means holds the recording medium between the turntable of the carriage chassis and the clamper of the clamping arm moved close to each other, and the optical pickup reads out data from the recording medium.

The cooperation member makes the carrying means and the clamping and reading out means cooperate with each other so that when the disc guide and the carrying roller of the carrying means are moved away from each other, the turntable and the clamper of the carriage chassis of the clamping and reading out means are moved close to each other, and when the disc guide and the carrying roller of the carrying means are moved close to each other, the turntable and the clamper of the carriage chassis of the clamping and reading out means are moved away from each other.

In the data processing device, in a case that the recording medium is received in the main body of the device, when the recording medium is positioned between the turntable and the clamper of the carriage chassis of the clamping and reading out means, the cooperation member moves the turntable and the clamper close to each other to clamp the recording medium therebetween, and moves the disc guide and the carrying roller of the carrying means away from each other. Then, in the data processing device, the recording medium is clamped between the turntable and the clamper, and the turntable rotates the recording medium, and then the optical pickup reads out data from the recording medium. Further, in the data processing device, in a case that the recording medium is ejected out of the main body of the device, after the cooperating member moves the turntable and the clamper of the carriage chassis of the clamping and reading out means away from each other, the cooperating member moves the disc guide and the carrying roller of the carrying means close to each other, and the recording medium is clamped between the disc guide and the carrying roller, and then the carrying means ejects the recording medium out of the main body of the device.

### PRIOR ART DOCUMENT

### Patent document

Patent Document 1: JP, A, 2002-329361

### DISCLOSURE OF THE INVENTION

### Problem to be Solved by the Invention

A case including: a main body of the case; a cover for holding the recording medium between the main body of the case and the cover; and a locking member projected from an inner wall of the main body of the case for locking the recording medium by entering a center hole of the recording medium is sometimes used as a case receiving the above-described recording medium. The locking member of such a case is made of elastically deformable material such as sponge, and attached to the inner wall of the main body of the case with an adhesive having adherence. In this case, when the recording medium is removed from the case, there is a chance that the locking member is removed from the inner wall of the main body of the case while the locking member is locked with the center hole of the recording media which has been removed from the main body of the case.

Then, when the recording medium is inserted into the main body of the device, the locking member is held between the turntable and the clamper, and stuck to the turntable with the above-described adhesive. In this case, a position of the recording medium in a thickness direction is different from the recording medium normally held between the turntable and the clamper, and not only the data fails to be read out from the recording medium, but also when the recording medium is tried to be ejected from the main body of the device by the carrying means, the recording medium fails to be ejected because the locking member is stuck to the turntable.

Accordingly, an object of the present invention is to provide a data processing device able to surely eject the recording medium out of the main body of the device even when the recording medium is received in a case while the locking member having adherence and elasticity of the case is locked with the center hole of the recording medium.

### Means for Solving the Problem

For attaining the object, according to the invention described in claim 1, there is provided a data processing device comprising:

a main body of the device;

a carrying means having a pair of clamping members for clamping a recording medium between the clamping members by moving the clamping members close and apart and a carrying roller mounted on at least one of the clamping members, the carrying means being disposed in the main body of the device configured to carry the recording medium in and out the main body of the device;

a clamping and reading out means having a turntable provided rotatably in the main body of the device, the clamping and reading out means being rotatable relative to the main body of the device to permit the recording medium to rotate; and

a controlling means configured to rotate the turntable while clamping the recording medium in an event of failure of ejecting the recording medium out of the main body of the device by the carrying means.

### BRIEF DESCRIPTION OF DRAWINGS

FIG. 1 A perspective view showing a CD player according to a first embodiment of the present invention.

FIG. 2 A perspective view showing a chassis, a clamping and reading out unit and the like of the CD player shown in FIG. 1.

FIG. 3 An explanatory view in a schematic manner showing a condition that a CD is inserted into the CD player shown in FIG. 1.

FIG. 4 An explanatory view in a schematic manner showing a condition that the CD inserted into the CD player shown in FIG. 3 is positioned between a carriage chassis and a clamping arm.

FIG. 5 An explanatory view in a schematic manner showing a condition that the CD inserted into the CD player shown in FIG. 4 is clamped by the clamping and reading out unit.

FIG. 6 A block diagram showing a schematic structure of the CD player shown in FIG. 1.

FIG. 7 A flowchart of an operation to eject the CD when pulling in focus of the CD player shown in FIG. 1 is failed.

FIG. 8 A flowchart of the operation to eject the CD when pulling in focus of the CD player according to a second embodiment of the present invention is failed.

### EXPLANATION OF REFERENCE

1 CD player (data processing device)
2 CD (recording medium)
2a center hole
3 main body of the device
4 microcomputer (controlling means)
5 carrying unit (carrying means)
6 clamping and reading out unit (clamping and reading out means)
17 disc guide (clamping member)
18 roller arm (clamping member)
20 carrying roller
26 turntable

### DESCRIPTION OF EMBODIMENTS

Hereinafter, a data processing device according to a first embodiment of the present invention will be explained. The data processing device according to the first embodiment of the present invention includes: a controlling means configured to rotate a turntable while a recording medium is clamped between a pair of clamping members when a carrying means fails to eject the recording medium out of a main body of the device. In this way, even when the recording medium is received in a case while a locking member having adherence and elasticity of the case is locked with a center hole of the recording medium, and stuck to the turntable, the turntable is rotated forcibly while the recording medium is clamped between the pair of clamping members and a rotation of the recording medium is prevented. Therefore, the locking member can be forcibly removed from the turntable. Therefore, the recording medium can be surely ejected out of the main body of the device.

Further, the controlling means may alternately make the carrying means eject the recording media, and make the turntable rotate while the pair of clamping members clamps the recording medium. In this case, when the carrying means ejects the recording medium, a rotation force is not applied to the recording medium. Namely, after the locking member is removed from the turntable, the recording medium is surely ejected out of the main body of the device. Therefore, the recording medium is prevented from being damaged by scraping against a carrying roller.

Further, when the controlling means makes the clamping and reading out means rotate the turntable, the controlling means may make the turntable rotate alternately in both directions opposite to each other. In this case, when an adhesive force between the turntable and the locking member is uneven, the locking member can be removed from an easier direction. Therefore, the locking member can be more surely removed from the turntable, and the recording medium can be more surely ejected out of the main body of the device.

Further, when the controlling means makes the clamping and reading out means rotate the turntable, the controlling means may make a rotation angle of the turntable gradually increase. In this case, when the locking member is not removed from the turntable, a load applied to a driving force for rotating the turntable can be suppressed to the minimum.

The controlling means may simultaneously make the carrying means eject the recording medium out of the main body of the device, and make the clamping and reading out means rotate the turntable. In this case, both a carrying force of the recording medium and a rotation force of the turntable remove the locking member from the turntable. Therefore, the locking member can be more surely removed from the turntable, and the recording medium can be more surely ejected out of the main body of the device.

### Embodiment 1

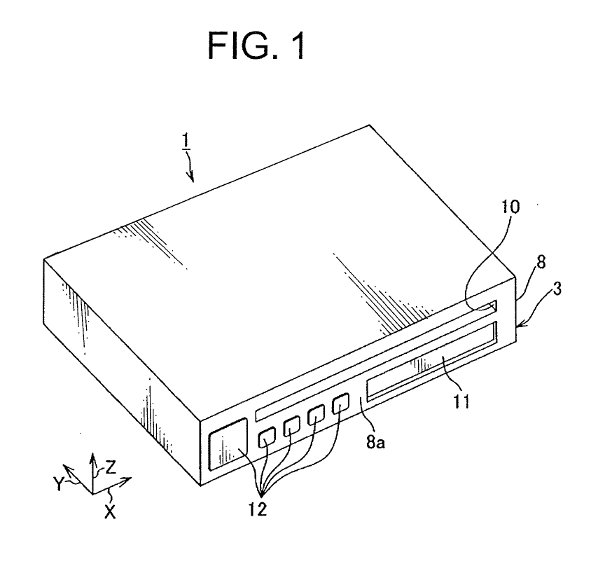

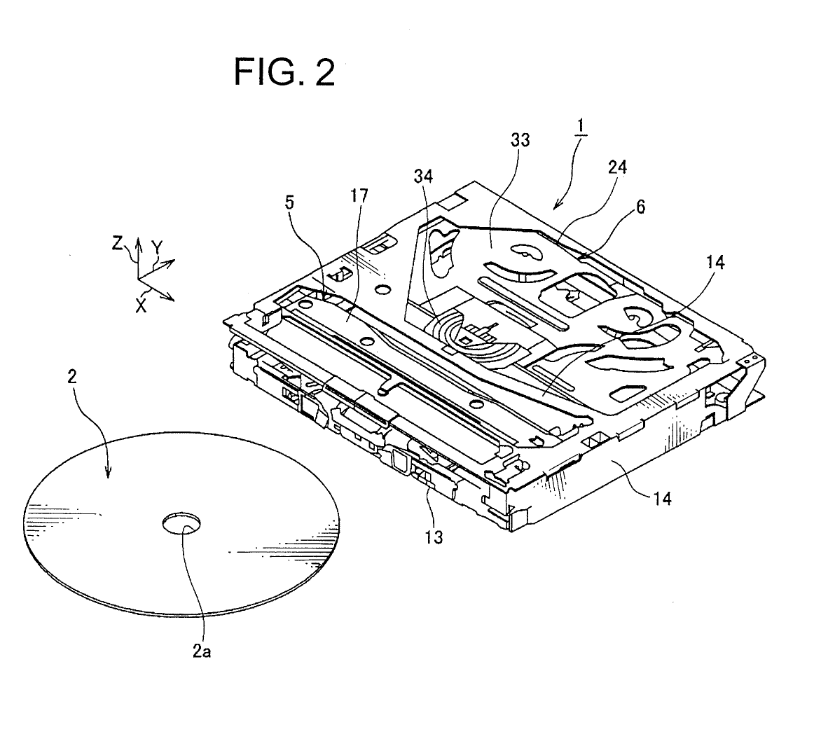

Hereinafter, a CD player 1 as the data processing device according to the first embodiment of the present invention will be explained with reference to FIGS. 1 to 7. The CD player 1 as shown in FIG. 1 and the like is attached to such as an instrument panel of a vehicle as a moving body, and receives one CD 2 (shown in FIG. 2) as the recording medium, and outputs audio by reading out data recorded on the CD 2.

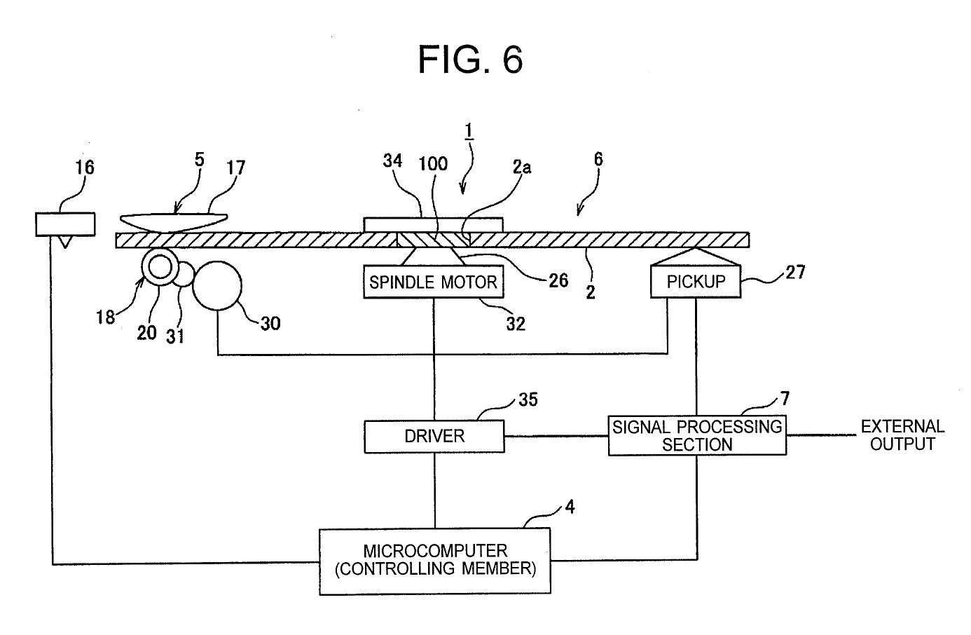

The CD 2 is, of course, formed in a disc shape, and is a recording medium recording data readable by an electronic device such as a computer. Further, a center hole 2a is provided in the center of the CD 2. The CD 2 is sometimes received in a case having a main body of the case, a cover for holding the CD 2 between the main body of the case and the case, and a locking member 100 (section thereof is shown in FIG. 6) attached to an inner wall of the main body of the case for locking with the center hole 2a. The locking member 100 is made of an elastically deformable material such as sponge, and attached to the inner wall of the main body of the case with adhesive having adherence. By locking with the center hole 2a of the CD 2 while attached to the inner wall of the main body of the case, the locking member 100 fixes the CD 2 to the main body of the case, namely, to the case.

As shown in FIGS. 1 and 2, the CD player 1 includes: a main body of the device 3 (shown in FIG. 1); a carrying unit 5 as the carrying means; a clamping and reading out unit 6 as the clamping and reading member; a cooperation mechanism as the cooperation member; a signal processing section 7 (shown in FIG. 6); and a microcomputer 4 (shown in FIG. 6) as the controlling means. Incidentally, hereinafter, an arrow Y direction in FIG. 1 parallel to both a surface of the CD 2 and a CD 2 carrying direction of the carrying unit 5 is referred to as a depth direction of the CD player 1. An arrow X direction parallel to the surface of the CD 2 and perpendicular to the depth direction Y is referred to as a width direction of the CD player 1. An arrow Z direction perpendicular to all of the surface of the CD 2, the depth direction Y, and the width direction X is referred to as a thickness direction of the CD player 1.

The main body of the device 3 includes: an outer case 8 shown in FIG. 1 and made of synthetic resin, metal, or the like; and a chassis 9 shown in FIG. 2.

The outer case 8 is formed in a flat box shape. One insertion slot 10 for ejecting or retracting the CD 2 is provided on a front wall 8a (shown in FIG. 1) of the outer case 8 facing a crew when attached to the above-described instrument panel. Incidentally, when the outer case 8, namely, the CD player 1 is attached to the instrument panel, the front wall 8a is one of the walls of the outer case 8 exposed outside from the instrument panel.

The insertion slot 10 penetrates an outer wall of the outer case 8. The CD 2 can be inserted into the insertion slot 10. The CD 2 is received in the outer case 8, namely, the main body of the device 3 and ejected from the main body of the device 3 via the insertion slot 10. Namely, the insertion slot 10 allows the CD 2 to be inserted into and ejected from the main body of the device 3.

Further, a display panel 11 and various switches 12 are provided on the front wall 8a.

The display panel 11 is exposed on the front wall 8a, and has a display wall as a display area for displaying various data to a user. The display panel 11 displays data such as a program name which is reproduced on the display wall.

The various switches 12 compose an operating section for a user operation. When the switches 12 are operated by the user, for example, a program of the CD 2 to be reproduced by the clamping and reading out unit 6 is selected, or the CD 2 is ejected or retracted.

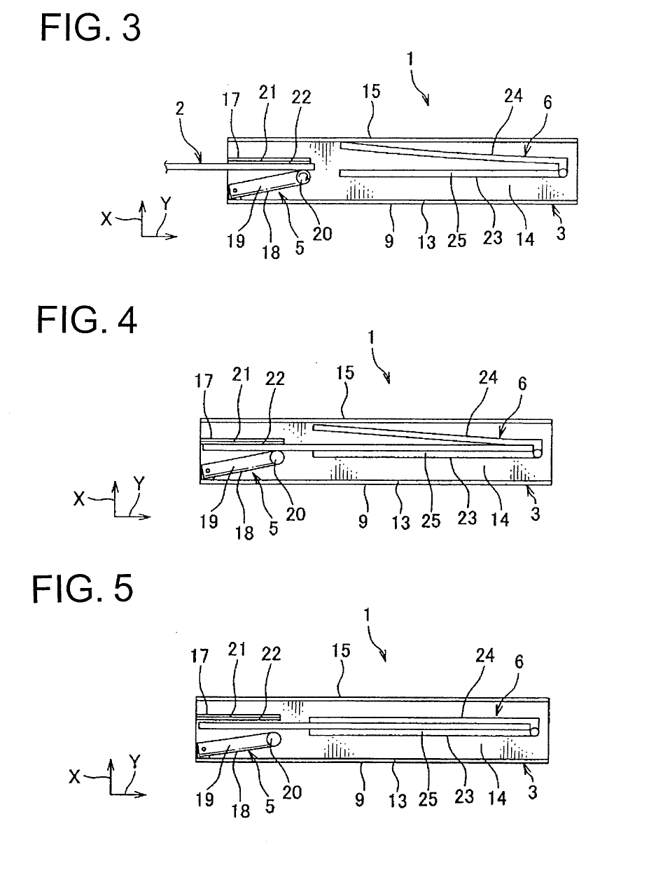

As shown in FIG. 2, a chassis 9 is made by a plurality of folded metal plates. As shown in FIGS. 2 and 3, the chassis 9 includes: a substantially flat bottom wall 13; a substantially flat ceiling wall 15 separated from the bottom wall 13; and a plurality of peripheral walls 14 continued to both the bottom wall 13 and the ceiling wall 15. A plurality of openings are respectively provided on the bottom wall 13, the peripheral walls 14, and the ceiling wall 15 for saving weight of the chassis 9 and securing rigidity of the chassis 9.

Further, a switch 16 (shown in FIG. 6) as a detecting member is provided around the insertion slot 10 of the chassis 9. A plurality of switches 16 are provided around the insertion slot 10 for detecting whether the CD 2 is inserted into the insertion slot 10 or not, or whether the CD 2 is completely ejected out of the insertion slot 10. The switch 16 outputs the detecting result to the microcomputer 4.

As shown in FIGS. 3 to 5, the carrying unit 5 includes: a roller arm 18; and a disc guide 17. The roller arm 18 is provided around the insertion slot 10. The roller arm 18 includes: an arm 19 made of metal plate or the like; and a carrying roller 20.

The arm 19 is formed in a band shape of which longitudinal direction is parallel to the width direction X. The arm 19 is supported by the bottom wall 13 rotatably about one edge in a width direction of the arm 19. A rotation center of the arm 19 is parallel to the width direction X. The arm 19 is biased by a not-shown coil spring in a direction which the other edge in the width direction of the arm 19 is separated from the bottom wall 13.

The carrying roller 20 is rotatably supported by the other edge of the arm 19. A rotation center of the carrying roller 20 is parallel to the width direction X. A not-shown gear is attached to one end of the carrying roller 20. While the other edge of the arm 19 is away from the bottom wall 13, the gear of the carrying roller 20 is engaged with a gear 31 (shown in FIG. 6) which is rotated by a carrying motor 30 (shown in FIG. 6) as a driving source or the like. The carrying roller 20 is rotated via the above-described gear 31 by a rotary driving force of the carrying motor 30. Incidentally, while the other end of the arm 19 is close to the bottom wall 13, the gear of the carrying roller 20 is not engaged with the above-described gear 31.

The disc guide 17 includes: a guide 21 made of metal plate or the like; and a flat-plate shaped sliding member 22 attached to the guide 21. The guide 21 is formed in a band shape of which longitudinal direction is parallel to the width direction X. The guide 21 is slidably supported along a vertical direction on the chassis 9 by a not-shown projecting pin and a guide hole into which the projecting pin is inserted. The sliding member 22 is made of synthetic resin having a low friction factor. The sliding member 22 is formed in a thin plate shape. The sliding member 22 is attached to a surface of the guide 21 positioned at an inside of the chassis 9.

The roller arm 18 and the disc guide 17 having the above-described structure are provided so as to move close to and away from each other. When the CD 2 is held between the roller arm 18 and the disc guide 17, and the carrying motor 30 rotates the carrying roller 20, the CD 2 is ejected or retracted from the main body of the device 3. Further, the roller arm 18 and the disc guide 17 having the above-described structure are referred to as the clamping member in the description. In this way, the carrying unit 5 includes a pair of clamping members, and the roller arm 18 as the one clamping member includes the carrying roller 20.

As shown in FIGS. 3 to 5, the clamping and reading out unit 6 includes: a carriage chassis 23; and a clamping arm 24. The carriage chassis 23 includes: a chassis 25 made of metal plate or the like; a turntable 26 (shown in FIG. 6) attached to the chassis 25; and a pickup 27 (shown in FIG. 6) attached to the chassis 25.

The chassis 25 is formed in a substantially flat plate shape. The turntable 26 is rotatably supported by the chassis 25. The turntable 26 is inserted into the center hole 2a of the CD 2. The turntable 26 rotates the CD 2 by a rotation of the turntable 26 due to a driving force of a spindle motor 32 (shown in FIG. 6) attached to the chassis 25.

The pickup 27 includes: a laser diode for emitting laser beam on a surface of the CD 2; an objective lens for emitting the laser beam from the laser diode on the surface of the CD 2; an actuator for driving the objective lens for focusing or tracking according to an instruction from the signal processing section 7; and an optical receiver for receiving reflect light reflected from the CD 2. The pickup controls focusing and tracking according to the instruction from the signal processing section 7, and reads data recorded on the CD 2.

The clamping arm 24 includes: an arm 33 made of metal plate or the like; and a clamper 34. The arm 33 is formed in a substantially plate shape. The arm 33 is rotatably supported by the chassis 25 of the carriage chassis 23 about an end away from the insertion slot 10. A rotation center of the arm 33 is parallel to the width direction X. When the arm 33 is moved close to the chassis 25, the chassis 25 and the arm 33 are substantially parallel to each other.

The clamper 34 is arranged facing the turntable 26. The clamper 34 is formed in a disc shape, and rotatably supported by the arm 33. When the arm 33 becomes substantially parallel to the chassis 25, the clamper 34 becomes allowed to clamp the CD 2 between the turntable 26 and the clamper 34. Further, the carriage chassis 23 and the clamping arm 24 of the clamping and reading out unit 6 are biased in a direction close to each other by a not-shown biasing member such as a spring.

Further, the clamping and reading out unit 6 is supported movably relative to the main body of the device 3 in the chassis 9 by a not-shown damper made of elastic member such as a rubber and by a coil spring. In the clamping and reading out unit 6, because the arm 33 of the clamping arm 24 is rotatably supported by the carriage chassis 23, the carriage chassis 23 and the clamping arm 24 are provided so as to move close to and away from each other. The clamping and reading out unit 6 reads data recorded on the CD 2 with a pickup when the clamping arm 24 and the carriage chassis 23 are moved close to each other, and the CD 2 is held between the turntable 26 and the clamper 34 (namely, clamping the CD 2 therebetween) and rotated by the spindle motor 32 and the turntable 26.

Further, the clamping and reading out unit 6 is moved relative to the chassis 9 by the damper and the coil spring even when the main body of the device 3 is vibrated due to a vibration of a running vehicle. In this way, the damper and the coil spring prevent the vibration of the running vehicle from negatively affecting on a readout operation of the data from the CD 2.

As shown in FIG. 3, before the CD 2 is received in the main body of the device 3, the cooperation mechanism moves the roller arm 18 of the carrying unit 5 and the disc guide 17 close to each other, and moves the carriage chassis 23 and the clamping arm 24 of the clamping and reading out unit 6 away from each other.

Then, as shown in FIG. 4, when the CD2 is inserted into the main body of the device 3 and the carrying motor 30 is rotated, the CD 2 is inserted into between the turntable 26 of the carriage chassis 23 and the clamper 34 of the clamping arm 24.

Then, as shown in FIG. 5, when the CD 2 is received in the main body of the device 3, the cooperation mechanism moves the roller arm 18 and the disc guide 17 of the carrying unit 5 away from each other, and moves the carriage chassis 23 and the clamping arm 24 of the clamping and reading out unit 6 close to each other.

In this way, the cooperation mechanism makes the clamping and reading out unit 6 and the carrying unit 5 cooperate with each other in a manner that when the carriage chassis 23 and the clamping arm 24 of the clamping and reading out unit 6 are moved close to each other, the roller arm 18 and the disc guide 17 of the carrying unit 5 are moved away from each other, and that when the roller arm 18 and the disc guide 17 of the carrying unit 5 are moved close to each other, the carriage chassis 23 and the clamping arm 24 of the clamping and reading out unit 6 are moved away from each other.

The signal processing section 7 is composed of a well-known amplifier, a servo signal processing section, an audio signal processing section, a memory, a converter, and the like. The signal processing section 7 amplifies a signal outputted from the pickup 27 to a specific value, and then controls focusing and tracking of the pickup 27 based on the amplified signal to correctly read out the data recorded on the CD 2. Further, the signal processing section 7 controls the carrying motor 30, the spindle motor 32, and the like according to the instruction from the microcomputer 4.

Further, the signal processing section 7 converts the digital signal including the data recorded on the CD 2 into the analog signal, demodulates the signal including the data recorded on the CD 2 into the audio signal, corrects errors, and then, converts the digital signal into the analog signal again, and outputs to an outer device such as a speaker.

Further, as shown in FIG. 6, a driver 35 is connected to the signal processing section 7. This signal processing section 7 is connected to the carrying motor 30, the spindle motor 32, and the pickup 27. The driver 35 amplifies a signal indicating an instruction inputted by the signal processing section 7, and outputs to the carrying motor 30, the spindle motor 32, and the pickup 27.

The microcomputer 4 integrally includes: a center processing unit (CPU) for processing various instructions according to a program; a ROM as a read-only memory for storing the program which the CPU processes; and a RAM as a readable and writable memory having a work area used for various processing process by the CPU, and a data store area for storing various data. These components are connected to each other with a bus line.

The microcomputer 4 is connected to the carrying unit 5, the clamping and reading out unit 6, the cooperation mechanism, the signal processing section 7, and the like. The microcomputer 4 control the operations of them and controls the whole CD player 1 according to the instruction inputted by the switch 12, or to the data indicating that the CD 2 is inserted from the switch 16.

As shown in FIG. 3, before the CD 2 is received in the main body of the device 3, namely, before the clamping and reading out unit 6 clamps the CD 2, the microcomputer 4 moves the roller arm 18 and the disc guide 17 of the carrying unit 5 close to each other, and moves the carriage chassis 23 and the clamping arm 24 of the clamping and reading out unit 6 away from each other. Then, when the CD 2 is inserted into the main body of the device 3, and the microcomputer 4 receives the signal indicating that the CD 2 is inserted into the insertion slot 10 from the switch 16, the microcomputer 4 makes the carrying roller 20 rotate by the carrying motor 30 of the carrying unit 5, and moves the CD 2 into the main body of the device 3.

Then, as shown in FIG. 4, when the CD 2 is positioned between the carriage chassis 23 and the clamping arm 24 of the clamping and reading out unit 6, the microcomputer 4 moves the carriage chassis 23 and the clamping arm 24 close to each other, and as shown in FIG. 5, the CD 2 is clamped between the carriage chassis 23 and the clamping arm 24. Further, as shown in FIG. 5, the microcomputer 4 moves the disc guide 17 and the roller arm 18 of the carrying unit 5 away from each other.

Thus, the microcomputer 4 makes the clamping and reading out unit 6 clamp the CD 2 by clamping the CD 2 between the carriage chassis 23 and the clamping arm 24. Further, while the clamping and reading out unit 6 clamps the CD 2, the microcomputer 4 makes the roller arm 18 and the disc guide 17 of the carrying unit 5 away from each other to prevent them from abutting on the CD 2 from which data is read out by the clamping and reading out unit 6.

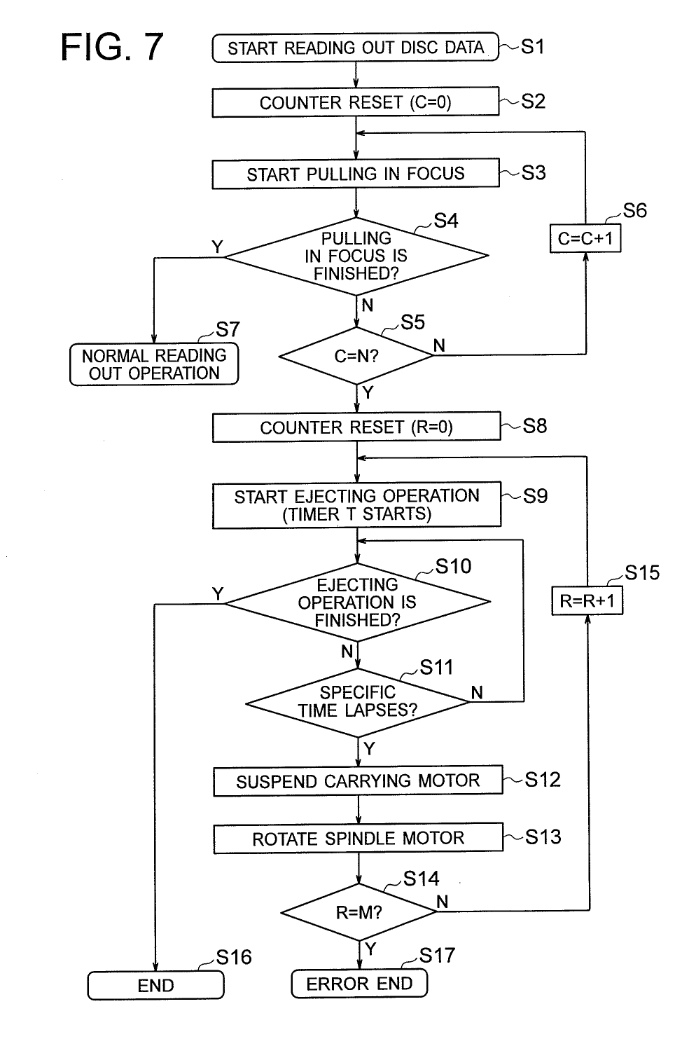

In this condition, the microcomputer 4 is in step S1 shown in FIG. 7, and goes to step S2 for start reading data recorded on the CD 2. In step S2, the microcomputer 4 resets a counter (C=0), and goes to step S3. In step S3, the microcomputer 4 instructs the signal processing section 7 to pull in focus. While pulling in focus, the signal processing section 7 outputs a control signal to the pickup 27 via the driver 35 so that the objective lens may be stopped around a zero-crossing point of a focus error signal in an S-shaped waveform outputted from the optical receiver of the pickup 27. Then, in step S4, the microcomputer 4 judges whether the pulling in focus is successful or not. When the pulling in focus is successful, the microcomputer 4 goes to step S7, and when the pulling in focus is failed, the microcomputer 4 goes to step S5. The success and failure of the pulling in focus relate to whether the objective lens is stopped around the zero-crossing point or not.

In step S7, the microcomputer 4 instructs the signal processing section 7 to set up of tracking and the like, and to read out data recorded on the CD 2. Then, in step S7, by rotating the spindle motor 32 and the like, a normal reading out operation from the CD 2 is performed.

In step S5, the microcomputer 4 judges whether the counter number C is a specific number N or not. When the counter number is not N, the counter number is incremented by one in step S6, and the microcomputer 4 goes back to step S3. When the counter number is the specific number N, the microcomputer 4 goes to step S8. Thus, when the pulling in focus is failed, the pulling in focus operation is repeated N times until the pulling in focus is successful.

At this time, when the CD 2 of which center hole 2a is locked with the locking member 100 is inserted into the main body of the device 3, and is held between the turntable 26 and the clamper 34, the pulling in focus is surely failed because the position of the CD 2 in the thickness direction Z is different from that of the normally clamped CD 2.

In step S8, the microcomputer 4 resets the counter (R=0), and goes to step S9. In step S9, the microcomputer 4 starts a timer and makes the cooperation mechanism clamp the CD 2 between the carrying roller 20 of the roller arm 18 and the disc guide 17 and move the carriage chassis 23 and the clamping arm 24 of the clamping and reading out unit 6 away from each other.

Then, the microcomputer 4 rotates the carrying roller 20 in a direction ejecting the CD 2 with the carrying motor 30, and goes to step S10. In the step S10, the microcomputer 4 judges whether the CD 2 is ejected or not. When the CD 2 is ejected, the microcomputer 4 goes to step S16 and an ejecting operation of the CD 2 is finished. When the CD 2 is not ejected, the microcomputer 4 goes to step S11.

Then, in step S11, the microcomputer 4 judges whether a specific time period lapses or not since the carrying roller 20 was started rotating. When the specific time period does not lapse, the microcomputer 4 goes back to step S10. When the specific time period lapses, the microcomputer 4 goes to step S12. Thus, the microcomputer 4 judges whether the CD 2 is ejected within the specific time period since the carrying roller 20 was started rotating or not. Incidentally, in step S10, the microcomputer 4 judges whether the CD 2 is ejected or not based on the data from the above-described switch 16. Further, when the CD2, of which center hole 2a the locking member 100 is inserted into, is clamped, the carrying unit 5 fails to eject the CD 2 because the locking member 100 closely attached to the turntable 26 due to adhesion force.

In step S12, the microcomputer 4 suspends the carrying motor 30, and goes to step S13. In step S13, while the CD 2 is clamped between the disc guide 17 of the carrying unit 5 and the carrying roller 20 of the roller arm 18, the microcomputer 4 rotates the turntable 26 in one direction in a specific angle with the spindle motor 32, and goes to step S14. In step S14, the microcomputer 4 judges whether the counter number R in step S8 is a specific number M or not. When the counter number R is not M, the counter number R is incremented by one in step S15, and the microcomputer 4 goes back to step S9. When the counter number R is the specific number M, the microcomputer 4 goes to step S17, an error message is displayed on the display panel 11, and an ejecting operation is finished. Thus, when the ejecting operation of the CD 2 is failed, the ejecting operation of the CD 2 is repeated the specific number M times until the ejecting operation of the CD 2 is successful.

Then, the microcomputer 4 goes back again to step S9, and rotates the carrying roller 20 to eject the CD 2 out of the main body of the device 3. Incidentally, when the CD 2 is not ejected within the specific time period in step S11, the spindle motor 32, namely, the turntable 26 is rotated in the other direction opposite to the previous one direction in step S13.

In this way, the microcomputer 4 alternately performs the one operation of making the carrying unit 5 eject the CD 2 out of the main body of the device 3 while stopping the turntable 26 and rotating the carrying roller 20, and the other operation of making the carrying roller 20 stop, the clamping and reading out unit 6 rotate the turntable 26 while the CD 2 is held between the carrying roller 20 of the roller arm 18 and the disc guide 17. Then, in step S13, when the turntable 26 is rotated, the microcomputer 4 makes the turntable 26 rotate alternately in both directions opposite to each other. Thus, when the carrying unit 5 fails to eject the CD 2 out of the main body of the device 3, the microcomputer 4 makes the turntable 26 rotate while the CD 2 is clamped between the carrying roller 20 of the roller arm 18 and the disc guide 17.

According to this embodiment, the CD player 1 includes the microcomputer 4 which makes the turntable 26 rotate while the CD 2 is clamped between the carrying roller 20 of the roller arm 18 and the disc guide 17 when the carrying unit 5 fails to eject the CD 2 out of the main body of the device 3. Therefore, even when the CD 2 of which center hole 2a is locked with the locking member 100 having adherence property and elasticity of the case is received in the main body of the device 3, and the locking member 100 is closely attached to the turntable 26, while the rotation of the CD 2 is prevented by clamping the CD 2 between the carrying roller 20 and the disc guide 17, the turntable 26 is forcibly rotated. Therefore, the locking member 100 is forcibly removed from the turntable 26. Therefore, the CD 2 is surely ejected out of the main body of the device 3.

Further, the microcomputer 4 alternately makes the carrying unit 5 eject the CD 2, and makes the turntable 26 rotate while the CD 2 is held between the carrying roller 20 of the roller arm 18 and the disc guide 17. Therefore, when the carrying unit 5 ejects the CD 2, a force for rotating the CD 2 is not applied. Namely, after the locking member 100 is surely removed from the turntable 26, the CD 2 is surely ejected out of the main body of the device 3, thereby the CD 2 is prevented from being damaged by scraping against the carrying roller 20.

Further, when the microcomputer 4 makes the clamping and reading out unit 6 rotate the turntable 26, the microcomputer 4 makes the turntable 26 rotate alternately in both directions opposite to each other. Therefore, when an adhesive force between the turntable 26 and the locking member 100 is uneven, the locking member 100 can be removed from an easier direction. Therefore, the locking member 100 can be more surely removed from the turntable 26, and the CD 2 can be more surely ejected out of the main body of the device 3.

Further, according to this embodiment, when the CD 2 fails to be ejected and operations in steps S9 to S15 are repeated, in step S13, each time the microcomputer 4 makes the clamping and reading out unit 6 rotate the turntable 26, the rotation angle of the turntable 26 may be gradually increased. In this case, the turntable 26 may be alternately rotated in both directions opposite to each other, or may be rotated in the same direction. In this case also, the locking member 100 can be more surely removed from the turntable 26, and the CD 2 can be more surely ejected out of the main body of the device 3. Further, in this case, when the locking member 100 is not removed from the turntable 26, the load applied to the driving force for rotating the turntable 26 can be suppressed to the minimum.

### Embodiment 2

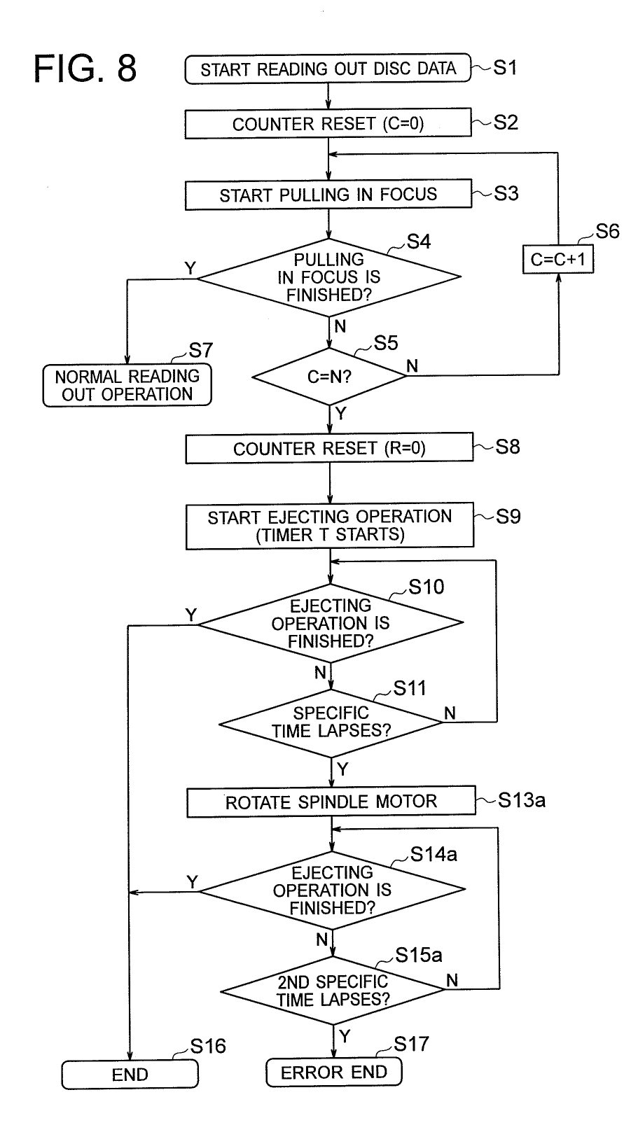

Next, the CD player 1 as the data processing device according to a second embodiment of the present invention will be explained with reference to FIG. 8. Incidentally, the same elements as the first embodiment are denoted by the same reference numerals and the explanation thereof is omitted. The CD player 1 of this embodiment is the same as the first embodiment except an operation of the microcomputer 4 when the CD 2 fails to be ejected.

In this embodiment, from step S10 to step S11, the microcomputer 4 starts rotating the carrying roller 20, then judges whether the CD 2 is ejected or not within a specific time period. When the CD 2 is not ejected within the specific time period, the microcomputer 4 goes to step S13a shown in FIG. 8. In step S13a, while the microcomputer 4 rotates the carrying roller 20, the microcomputer 4 makes the spindle motor 32 rotate the turntable 26, and goes to step S14a.

In step S14a, the microcomputer 4 judges whether the CD 2 is ejected or not. When the CD 2 is ejected, the microcomputer 4 goes to step S16 and the ejecting operation of the CD 2 is finished. When the CD 2 is not ejected, the microcomputer 4 goes to step S15a. In step S15a, the microcomputer 4 judges whether a second specific time period lapses since the above-described turntable 26 started rotating or not. When the second specific time period does not lapse, the microcomputer 4 goes back to step S14a. When the second specific time period lapses, the microcomputer 4 goes to step S17. Thus, the microcomputer 4 judges whether the CD 2 is ejected within the second specific time period since the turntable 26 started rotating. In this way, according to this embodiment, the microcomputer 4 simultaneously makes the carrying unit 5 eject the CD 2 out of the main body of the device 3 by rotating the carrying roller 20, and makes the clamping and reading out unit 6 rotate the turntable 26.

According to this embodiment, the microcomputer 4 simultaneously makes the carrying unit 5 eject the CD 2 out of the main body of the device 3, and makes the clamping and reading out unit 6 rotate the turntable 26. In this case, the locking member 100 is removed from the turntable 26 by both a carrying force of the CD 2 and a rotation force of the turntable 26. Accordingly, the locking member 100 can be more surely removed from the turntable 26, and the CD 2 can be more surely ejected out of the main body of the device 3.

According to the above-described embodiment, the CD player 1 described below is attained.

### (Additional Remark)

A CD player 1 comprising:

a main body of the device 3;

a carrying unit 5 having a disc guide 17 and a roller arm 18 for clamping a CD 2 between the disc guide 17 and the roller arm 18 by moving the disc guide 17 and the roller arm 18 close and apart and a carrying roller 20 mounted on at least one of the disc guide 17 and the roller arm 18, the carrying unit 5 being disposed in the main body of the device 3 configured to carry the CD 2 in and out the main body of the device 3;

a clamping and reading out unit 6 having a turntable 26 provided rotatably in the main body of the device 3, the clamping and reading out unit 6 being rotatable relative to the main body of the device 3 to permit the CD 2 to rotate; and

a microcomputer 4 configured to rotate the turntable 26 while clamping the CD 2 in an event of failure of ejecting the CD 2 out of the main body of the device 3 by the carrying unit 5.

According to the additional remark, the CD player 1 includes the microcomputer 4 configured to rotate the turntable 26 while the CD 2 is clamped between the disc guide 17 and the roller arm 18 of the carrying roller 20 of the carrying unit 5 when the carrying unit 5 fails to eject the CD 2 out of the main body of the device 3. Therefore, even when the CD 2 of which center hole 2a is locked with the locking member 100 having adherence property and elasticity of the case is received in the main body of the device 3, and the locking member 100 is closely attached to the turntable 26, while the rotation of the CD 2 is prevented by clamping the CD 2 between the carrying roller 20 and the disc guide 17, the turntable 26 is forcibly rotated. Therefore, the locking member 100 is forcibly removed from the turntable 26. Therefore, the CD 2 is surely ejected out of the main body of the device 3.

According to the present invention, the data processing device may read out data from not only the CD 2 but also various recording medium. Further, the data processing device may receive not only the CD 2 but also a plurality of recording media. Further, according to the present invention, the carrying roller 20 may be provided on both of the pair of clamping member of the carrying unit 5.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

1. A data processing device comprising:
a main body of the device;
a carrying means having a pair of clamping members for clamping a recording medium between the clamping members by moving the clamping members close and apart and a carrying roller mounted on at least one of the clamping members, the carrying means being disposed in the main body of the device configured to carry the recording medium in and out the main body of the device;
a clamping and reading out means having a turntable provided rotatably in the main body of the device, the clamping and reading out means being rotatable relative to the main body of the device to permit the recording medium to rotate; and
a controlling means configured to rotate the turntable while clamping the recording medium in an event of failure of ejecting the recording medium out of the main body of the device by the carrying means.

2. The data processing device as claimed in claim 1,
wherein the controlling means performs such an operation alternately that the carrying means ejects the recording medium out of the main body of the device by rotating the carrying roller while stopping the turntable and that the clamping and reading out means rotates the turntable by stopping the carrying roller while clamping the recording medium between the pair of clamping members.

3. The data processing device as claimed in claim 2,
wherein the controlling means configures means to rotate the turntable alternately in both directions opposite to each other by means of the clamping and reading out means when it is rotated.

4. The data processing device as claimed in claim 2,
wherein when the controlling means configures to increase a rotation angle of the turntable gradually at every time by means of the clamping and reading out means when it is rotated.

5. The data processing device as claimed in claim 1,
wherein the controlling means configures to eject the recording medium out of the main body of the device by means of the carrying means by rotating the carrying roller, and to rotate the turntable simultaneously by means of the clamping and reading out means.
